(19) United States
(12) Patent Application Publication
(10) Pub. No.: US 2026/0257500 A1
(43) Pub. Date: Sep. 3, 2026

(54) PRINTER, METHOD, AND STORAGE MEDIUM

(71) Applicant: Toshiba Tec Kabushiki Kaisha, Tokyo (JP)

(72) Inventor: Kazunori UEMATSU, Tagata Shizuoka (JP)

(21) Appl. No.: 19/412,771

(22) Filed: Dec. 8, 2025

(30) Foreign Application Priority Data
Mar. 3, 2025 (JP) 2025-032523

(51) Int. Cl. B41J 11/66; B41J 11/04

(52) U.S. Cl. CPC B41J 11/663; B41J 11/04; B41J 11/666

(57) ABSTRACT

A printer includes a platen roller, a print head, a cutter, and a housing that has a sheet ejection port through which a sheet fed from a sheet roll is ejected after printing, the housing being placeable in a forward ejection orientation in which the sheet ejection port faces forward and an upward ejection orientation in which the sheet ejection port faces upward; a memory; and a processor configured to execute a program stored in the memory to perform the steps of: determining whether a cutting mode of the printer is set to a full cut mode or a partial cut mode, detecting whether the housing is placed in the forward ejection orientation or the upward ejection orientation, and setting the cutting mode to the partial cut mode regardless of the determined cutting mode when the housing is placed in the upward ejection orientation.

### CROSS-REFERENCE TO RELATED APPLICATION

This application is based upon and claims the benefit of priority from Japanese Patent Application No. 2025-032523, filed Mar. 3, 2025, the entire contents of which are incorporated herein by reference.

### FIELD

Embodiments described herein relate generally to a printer, a method, and a storage medium.

### BACKGROUND

In a known printer, the ejection direction of printed material can be changed between a forward direction (hereinafter referred to as a forward ejection mode) or an upward direction (hereinafter referred to as an upward ejection mode) by changing the orientation (a forward ejection orientation or an upward ejection orientation) of the printer.

Also, there is a printer that enables the user to select between a full cut mode in which printed material is completely cut off from a sheet roll and a partial cut mode in which printed material is partially cut such that a portion of the printed material remains attached to the sheet roll.

With the related-art technology, however, when printed material is completely cut off in the full cut mode while the printer is set to the upward ejection mode, the cut-off printed material may drop into the printer through a sheet ejection port. The printed material dropped into the printer may be cut into pieces when the next printed material is cut, and the pieces of the printed material may be accumulated inside the printer, which results in clogging of the printer.

### SUMMARY OF THE INVENTION

Embodiments of the present disclosure provide a printer, a method, and a storage medium that can prevent clogging of the printer resulting from the accumulation of pieces of a print sheet even when the printer is oriented such that the print sheet is ejected upward.

According to an aspect of the present disclosure, a printer includes a platen roller that feeds a sheet from a sheet roll; a print head that performs printing on the sheet; a cutter that cuts the sheet after the printing; a housing that houses the platen roller, the print head, and the cutter and has a sheet ejection port through which the sheet is ejected after the printing, the housing being placeable in a forward ejection orientation in which the sheet ejection port faces forward and an upward ejection orientation in which the sheet ejection port faces upward; a memory; and a processor configured to execute a program that is stored in the memory to perform the steps of: determining whether a cutting mode of the printer is set to a full cut mode in which the cutter completely cuts off the sheet from the sheet roll or a partial cut mode in which the cutter partially cuts the sheet such that a portion of the sheet remains attached to the sheet roll, detecting whether the housing is placed in the forward ejection orientation or the upward ejection orientation, and setting the cutting mode to the partial cut mode regardless of the determined cutting mode when the housing is placed in the upward ejection orientation.

### BRIEF DESCRIPTION OF THE DRAWINGS

FIG. 1 is a cross-sectional view illustrating an example of a schematic internal configuration of a receipt printer according to an embodiment.

FIG. 2 is a perspective view illustrating an example in which the receipt printer is placed in a forward ejection orientation.

FIG. 3 is a perspective view illustrating an example in which the receipt printer is placed in an upward ejection orientation.

FIG. 4 is a diagram illustrating an example of a configuration of a cutter included in the receipt printer.

FIG. 5 is a diagram illustrating an example of a state in which the cutter included in the receipt printer has completely cut off a receipt sheet.

FIG. 6 is a diagram illustrating an example of a state in which the cutter included in the receipt printer has partially cut a receipt sheet.

FIG. 7 is a hardware block diagram illustrating an example of a hardware configuration of the receipt printer.

FIG. 8 is a functional block diagram illustrating an example of a functional configuration of the receipt printer.

FIG. 9 is a flowchart illustrating an example of a process performed by the receipt printer.

### DETAILED DESCRIPTION

Hereinafter, a receipt printer 10 according to an embodiment of the present disclosure will be described in detail with reference to the accompanying drawings.

### Overall Configuration of Receipt Printer

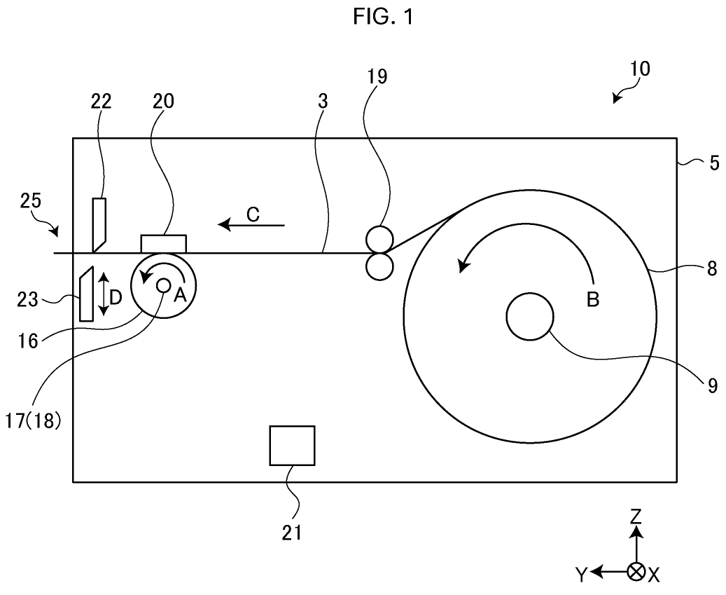

A schematic configuration of the receipt printer 10 according to the present embodiment will be described with reference to FIG. 1. FIG. 1 is a cross-sectional view illustrating an example of a schematic internal configuration of the receipt printer 10. The receipt printer 10 is an example of a printer according to the present disclosure.

The receipt printer 10 prints a receipt while feeding a receipt sheet 3 from a sheet roll 8 formed by winding the receipt sheet 3 around a roll core 9. The receipt sheet 3 is an example of a sheet according to the present disclosure.

The receipt printer 10 includes a conveyance roller 19, a platen roller 16, a thermal head 20, and a cutter including a fixed blade 22 and a movable blade 23 that are housed in a housing 5. The thermal head 20 is an example of a print head according to the present disclosure.

The conveyance roller 19 is a free roller that forms a conveyance path for guiding the receipt sheet 3 fed from the sheet roll 8 toward the thermal head 20 in a direction indicated by an arrow C.

The platen roller 16 is rotated in a direction indicated by an arrow A around a shaft 18 by a driving force transmitted from a platen roller drive motor 17 and thereby feeds the receipt sheet 3 in a direction indicated by an arrow B from one end of the sheet roll 8. The fed receipt sheet 3 is conveyed toward the thermal head 20.

The thermal head 20 is disposed such that the longitudinal direction of the thermal head 20 is orthogonal to the conveyance direction of the receipt sheet 3 and includes a plurality of heating elements that are aligned in a line. The thermal head 20 is pressed against the platen roller 16. The receipt sheet 3 is sandwiched between the thermal head 20 and the platen roller 16 and conveyed toward a sheet ejection port 25 formed in the housing 5. The thermal head 20 performs printing on a printing surface (a surface on the positive Z-axis side in FIG. 1) of the receipt sheet 3 sandwiched between the thermal head 29 and the platen roller 16 by causing heating elements corresponding to a printing pattern to generate heat.

The cutter cuts the receipt sheet 3 ejected from the sheet ejection port 25 after printing is completed. The movable blade 23 is driven by a movable blade drive motor 241 (see FIG. 7) described later to move back and forth in a direction indicated by an arrow D in FIG. 1. The movable blade 23 contacts, overlaps, and moves along the fixed blade 22 to cut the receipt sheet 3 ejected from the sheet ejection port 25. In other words, the movable blade drive motor 241 is controlled to move the movable blade 23 relative to the fixed blade 22 to cut the receipt sheet 3. The movable blade drive motor 241 is an example of a drive motor according to the present disclosure.

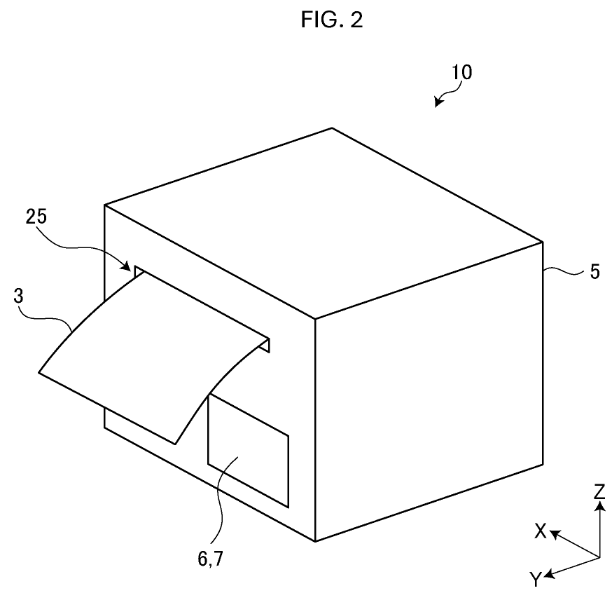

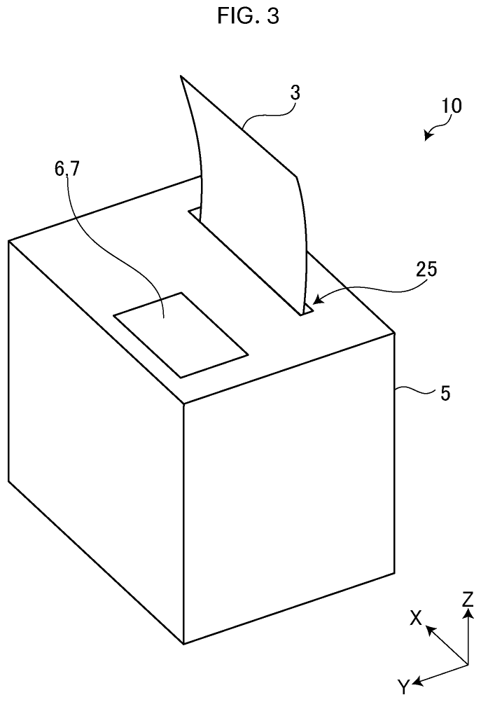

The receipt printer 10 includes an acceleration sensor 21 inside the housing 5. The acceleration sensor 21 detects the direction of gravity acting on the acceleration sensor 21. The acceleration sensor 21 is implemented by a known sensor, such as a sensor for detecting the distortion of a piezo resistance element that changes according to acceleration or a sensor that detects electrostatic capacitance between a fixed part and a movable part that changes according to acceleration. The receipt printer 10 determines whether the housing 5 of the receipt printer 10 is oriented such that the sheet ejection port 25 faces forward (see FIG. 2) or upward (see FIG. 3) based on an output signal from the acceleration sensor 21.

Although the present embodiment is described by taking the receipt printer 10 as an example, the present disclosure may also be applied to any printer, such as a label printer, other than the receipt printer 10.

### Orientation of Receipt Printer

The orientation of the receipt printer 10 will be described with reference to FIGS. 2 and 3. FIG. 2 is a perspective view illustrating an example in which the receipt printer 10 (or housing 5) is placed in a forward ejection orientation. FIG. 3 is a perspective view illustrating an example in which the receipt printer 10 (or housing 5) is placed in an upward ejection orientation.

The orientation of the receipt printer 10 can be switched, according to the installation location, the use condition, or the like, between the forward ejection orientation in which the sheet ejection port 25 faces forward and the upward ejection orientation in which the sheet ejection port 25 faces upward by rotating the housing 5. In other words, the housing 5 is placeable in the forward ejection orientation and the upward ejection orientation.

FIG. 2 shows an example in which the receipt printer 10 is placed in the forward ejection orientation such that the sheet ejection port 25 faces forward. In this case, the printed receipt sheet 3 is ejected horizontally along the Y axis.

FIG. 3 shows an example in which the receipt printer 10 is placed in the upward ejection orientation such that the sheet ejection port 25 faces upward. In this case, the printed receipt sheet 3 is ejected upward along the Z-axis.

The receipt printer 10 includes a display device 6 that displays an operation state of the receipt printer 10, and an operating device 7 that receives various instructions for the receipt printer 10. The display device 6 is, for example, a liquid crystal display, an organic EL display, or the like. The operating device 7 is, for example, a touch panel, physical switches, or the like. The display device 6 and the operating device 7 are disposed on the same surface of the housing 5 in which the sheet ejection port 25 is formed. That is, the display device 6 and the operating device 7 face a direction that is the same as the direction in which the receipt sheet 3 is ejected This makes it possible to improve the operability of the receipt printer 10.

### Configuration of Cutter

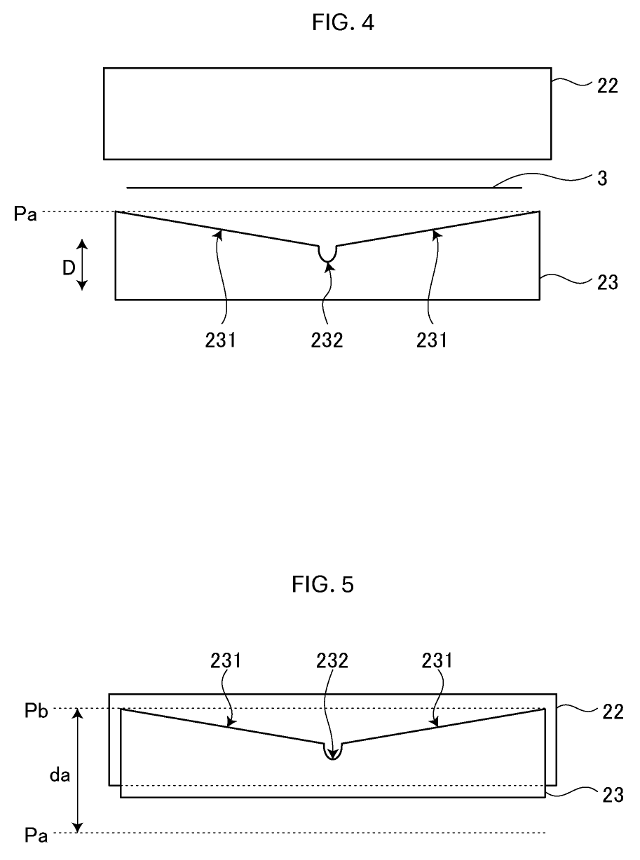

A configuration of the cutter included in the receipt printer 10 will be described with reference to FIG. 4. FIG. 4 is a diagram illustrating a configuration of the cutter included in the receipt printer 10 according to the embodiment.

The movable blade 23 includes a blade edge 231 that has a bilaterally symmetrical shape and is formed on a side facing the fixed blade 22. The blade edge 231 slopes down from both ends toward its center portion. A notch 232 is formed in the center portion of the blade edge 231. The tip of the movable blade 23 stays at the initial position (home position), that is, a position Pa shown in FIG. 4, when no instruction to cut the receipt sheet 3 has been acquired from the receipt printer 10.

When an instruction to cut the receipt sheet 3 is acquired from the receipt printer 10, the movable blade 23 moves back and forth along the arrow D in FIG. 4 to cut the receipt sheet 3. Any known method may be used to move the movable blade 23 back and forth along the arrow D, and therefore, detailed descriptions of the method are omitted. For example, the movable blade 23 is moved back and forth along the arrow D by a cam mechanism (not shown) that converts the rotational force of the movable blade drive motor 241 (see FIG. 7) into a driving force for moving the movable blade 23.

A movement path of the receipt sheet 3 is formed between the movable blade 23 and the fixed blade 22. When the receipt printer 10 instructs the movable blade drive motor 241 to cut the receipt sheet 3, the movable blade 23 at the initial position is moved upward along the arrow D and engages the fixed blade 22 to cut the receipt sheet 3. After cutting the receipt sheet 3, the movable blade 23 moves downward along the arrow D and returns to the initial position.

### Cut States of Receipt

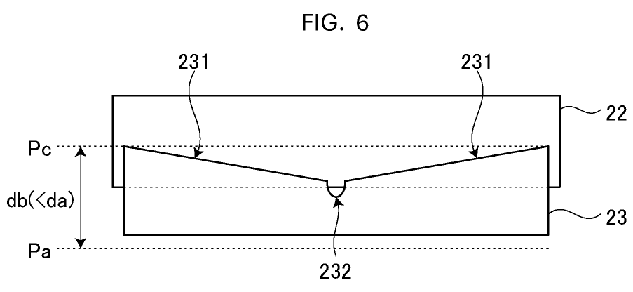

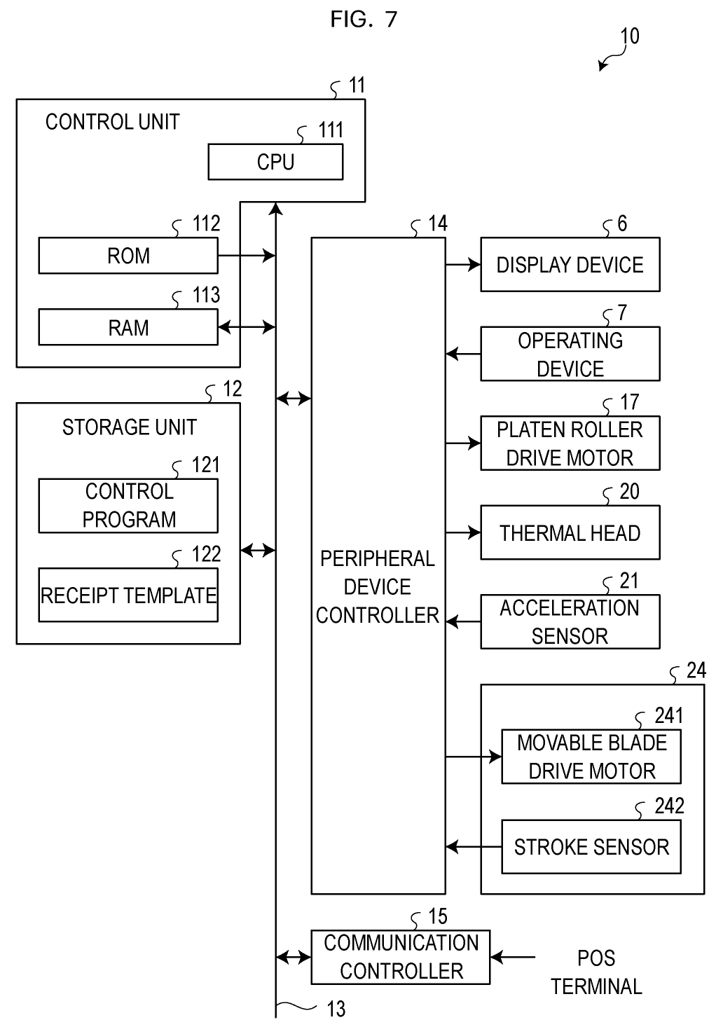

Cut states of the receipt sheet 3 will be described with reference to FIGS. 5 and 6. FIG. 5 is a diagram illustrating an example of a state in which the cutter included in the receipt printer 10 according to the embodiment has completely cut off the receipt sheet 3 from the sheet roll 8. FIG. 6 is a diagram illustrating an example of a state in which the cutter included in the receipt printer 10 according to the embodiment has partially cut the receipt sheet 3 such that a portion of the receipt sheet 3 remains attached to the sheet roll 8.

The receipt printer 10 can set the cutting mode for cutting the receipt sheet 3 on which printing has been completed to either a full cut mode or a partial cut mode.

In the full cut mode, the receipt sheet 3 on which printing has been completed is completely cut off from the sheet roll 8.

In the partial cut mode, the receipt sheet 3 on which printing has been completed is partially cut such that a portion of the receipt sheet 3 remains attached to the sheet roll 8. The receipt sheet 3 that has been partially cut needs to be torn off by the clerk or the customer.

FIG. 5 shows an example of a state in which the movable blade 23 is raised to the highest position for completely cutting off the receipt sheet 3.

In this case, the tip of the movable blade 23 is raised by a distance da from the position Pa, which is the initial position, to a position Pb.

FIG. 6 shows an example of a state in which the movable blade 23 is raised to the highest position for partially cutting the receipt sheet 3.

In this case, the tip of the movable blade 23 is raised by a distance db from the position Pa, which is the initial position, to a position Pc. The distance db is less than the distance da by which the tip of the movable blade 23 is raised to completely cut off the receipt sheet 3.

When the tip of the movable blade 23 is raised to the position Pc, the notch 232 of the movable blade 23 is raised to the conveyance position of the receipt sheet 3. In other words, the movable blade 23 is moved until the notch 232 reaches a position at which the receipt sheet 3 is conveyed. Therefore, a portion of the receipt sheet 3 corresponding to the region of the notch 232 is not cut. That is, the receipt sheet 3 is partially cut such that the central portion of the receipt sheet 3 in the width direction remains attached to the sheet roll 8.

The receipt printer 10 changes the distance by which the movable blade 23 is raised depending on whether the full cut mode or the partial cut mode is selected. In the present embodiment, the receipt printer 10 includes a stroke sensor 242 (see FIG. 7) that detects the distance by which the movable blade 23 is raised. In the partial cut mode, the movable blade 23 is prevented from rising any further when the stroke sensor 242 detects that the tip of the movable blade 23 has been raised from the initial position by the distance db. That is, the distance by which the movable blade 23 is moved is controlled based on a detection signal from the stroke sensor 242. The stroke sensor 242 is, for example, a reflective photosensor or a transmissive photosensor that detects the position of the tip of the raised movable blade 23. The stroke sensor 242 may have any configuration as long as the stroke sensor 231 can detect the position of the tip of the movable blade 23 that has been raised. Also, the method of controlling the distance by which the movable blade 23 is raised in the full cut mode and the partial cut mode is not limited to the above example, and any known method may be used.

### Hardware Configuration of Receipt Printer

A hardware configuration of the receipt printer 10 according to the embodiment will be described with reference to FIG. 7. FIG. 7 is a hardware block diagram illustrating a hardware configuration of the receipt printer 10 according to the embodiment.

As shown in FIG. 7, the receipt printer 10 includes a control unit 11, a storage unit 12, a peripheral device controller 14, and a communication controller 15 that are connected to each other via an internal bus 13.

The control unit 11 controls the overall operation of the receipt printer 10. The control unit 11 includes a central processing unit (CPU) 111, a read-only memory (ROM) 112, and a random access memory (RAM) 113. The CPU 111 is connected to the ROM 112 and the RAM 113 via internal buses, such as an address bus and a data bus. The CPU 111 loads various programs stored in the ROM 112 or the storage unit 12 into the RAM 113. The CPU 111 controls the operation of the receipt printer 10 by executing the various programs loaded into the RAM 113. That is, the control unit 11 has a configuration of a general computer. The CPU 111 is an example of a processor, and each of the storage unit 12, the ROM 112, and the RAM 113 is an example of a memory according to the present disclosure.

The storage unit 12 is a storage device, such as a hard disk drive (HDD) or a solid-state drive (SSD). The storage unit 12 may be a nonvolatile memory, such as a flash memory that retains stored information even when the power is turned off. The storage unit 12 stores a control program 121 and a receipt template 122.

The control program 121 is a program for controlling the overall operation of the receipt printer 10. The control program 121 may be prestored in the storage unit 12 or may be provided on a computer-readable non-transitory storage medium, such as a CD-ROM, a flexible disk (FD), a CD-R, or a DVD in an installable format or an executable format. Also, the control program 121 may be stored in a computer connected to a network and downloaded via the network. Furthermore, the control program 121 may be provided or distributed via a network, such as the Internet.

The receipt template 122 is a master file storing templates of receipts to be printed by the receipt printer 10. The receipt template 122 includes layout data, store logo data, and the like. The receipt printer 10 prints a receipt by using a template selected by the operator.

The control unit 11 is connected to various input/output devices, such as the display device 6, the operating device 7, the platen roller drive motor 17, the thermal head 20, the acceleration sensor 21, and a movable blade unit 24, via the peripheral device controller 14. The movable blade unit 24 includes the movable blade drive motor 241 and the stroke sensor 242. Because these input/output devices are described above, their descriptions are not repeated here.

The control unit 11 is connected to a POS terminal (not shown) via the communication controller 15 in a wired or wireless manner. The receipt printer 10 acquires print information of receipts from the POS terminal.

### Functional Configuration of Receipt Printer

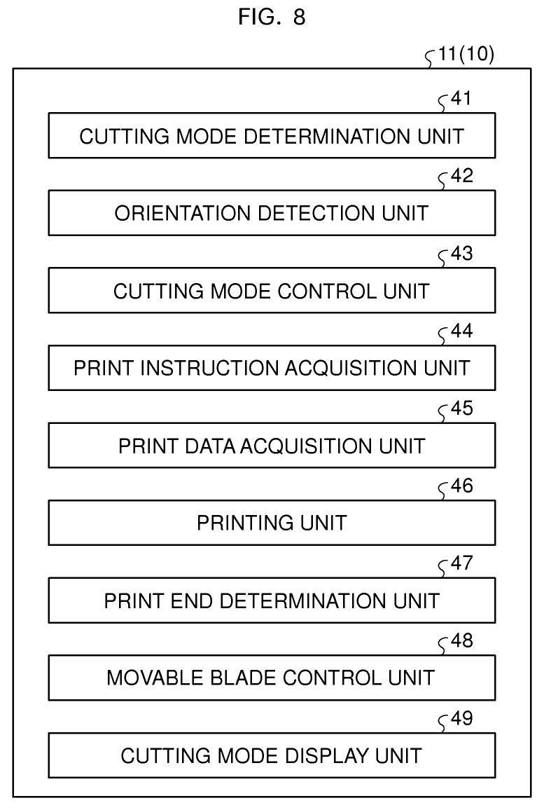

A functional configuration of the receipt printer 10 will be described with reference to FIG. 8. FIG. 8 is a functional block diagram illustrating a functional configuration of the receipt printer 10 according to the embodiment.

The control unit 11 of the receipt printer 10 loads the control program 121 into the RAM 113 and executes the loaded control program 300 to implement a cutting mode determination unit 41, an orientation detection unit 42, a cutting mode control unit 43, a print instruction acquisition unit 44, a print data acquisition unit 45, a printing unit 46, a print end determination unit 47, a movable blade control unit 48, and a cutting mode display unit 49 illustrated in FIG. 8 as functional units. Note that some or all of these functional units may be implemented by dedicated hardware.

The cutting mode determination unit 41 determines whether the cutting mode of the receipt sheet 3 is set to the full cut mode for completely cutting off the receipt sheet 3 from the sheet roll 8 or the partial cut mode for partially cutting the receipt sheet 3 such that a portion of the receipt sheet 3 remains attached to the sheet roll 8. Specifically, the cutting mode determination unit 41 determines the cutting mode of the receipt printer 10 based on information indicating whether the full cut mode or the partial cut mode is selected in an operation menu of the receipt printer 10. In other words, the cutting mode determination unit 41 determines the cutting mode of the receipt printer 10 based on information indicating a selection made by the operator (or user) via the operating device 7.

The orientation detection unit 42 detects whether the housing 5 of the receipt printer 10 is in a forward ejection orientation in which the receipt sheet 3 on which printing has been completed is ejected forward from the receipt printer 10 or an upward ejection orientation in which the receipt sheet 3 on which printing has been completed is ejected upward from the receipt printer 10. Specifically, the orientation detection unit 42 detects the orientation of the housing 5 based on an output signal from the acceleration sensor 21.

When the orientation detection unit 42 detects that the housing 5 of the receipt printer 10 is in the upward ejection orientation, the cutting mode control unit 43 sets the cutting mode of the receipt sheet 3 to the partial cut mode regardless of the cutting mode determined by the cutting mode determination unit 41.

The print instruction acquisition unit 44 acquires a print instruction to print a receipt on the receipt sheet 3 from the POS terminal.

The print data acquisition unit 45 acquires print data to be printed on the receipt sheet 3 from the POS terminal.

The printing unit 46 performs printing on the receipt sheet 3.

The print end determination unit 47 determines whether all the print data acquired by the print data acquisition unit 45 has been printed.

When the print end determination unit 47 determines that the printing has been completed, the movable blade control unit 48 cuts the receipt sheet 3 according to the full cut mode or the partial cut mode that is currently set.

The cutting mode display unit 49 displays the current cutting mode of the receipt printer 10 on the display device 6. When the housing 5 is in the upward ejection orientation and the receipt printer 10 is set to the full cut mode, the cutting mode display unit 49 preferably displays a message, such as "The cutting mode is changed to the partial cut mode because the housing is placed in the upward ejection orientation", on the display device 6. In other words, when the housing 5 is placed in the upward ejection orientation while the cutting mode of the receipt printer 10 is set to the full cut mode, the full cut mode is changed to the partial cut mode and the display device 6 is controlled to display a message indicating that the cutting mode has been changed to the partial cut mode.

### Process Performed by Receipt Printer

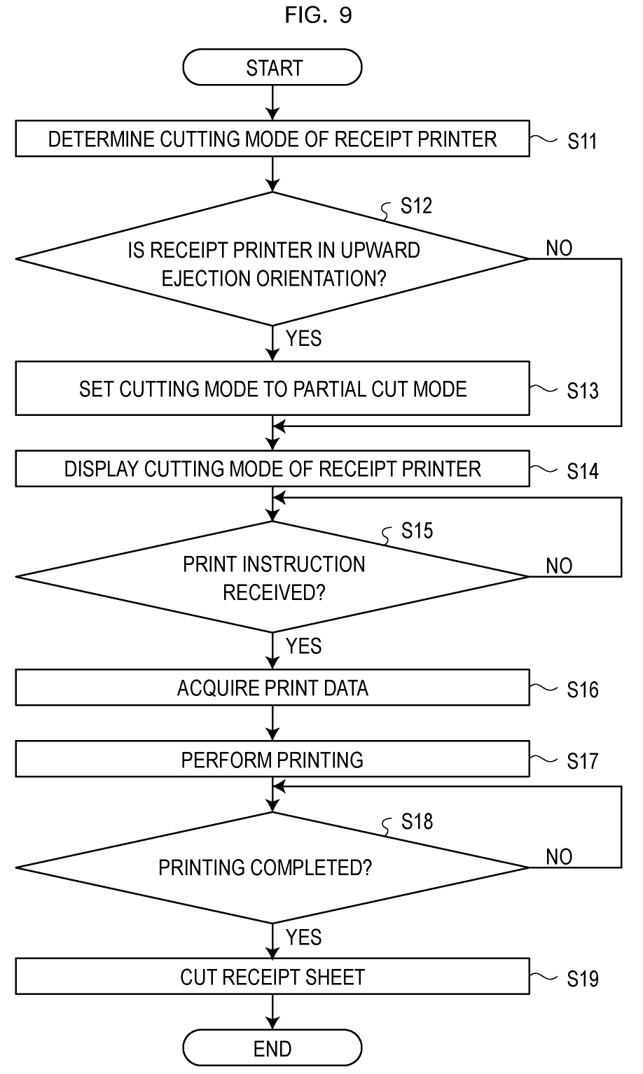

A process performed by the receipt printer 10 according to the embodiment will be described with reference to FIG. 9. FIG. 9 is a flowchart illustrating an example of a process performed by the receipt printer 10. The CPU 11 (or processor) of the receipt printer 10 (or printer) is configured to execute the control program 12 (or program) stored in the storage unit 12, the ROM 112, or the RAM 113 (or memory) to perform the steps in the process described below.

The cutting mode determination unit 41 determines whether the cutting mode of the receipt printer 10 is set to the full cut mode or the partial cut mode (step S11).

The orientation detection unit 42 determines whether the housing 5 of the receipt printer 10 is placed in the upward ejection orientation (step S12). When it is determined that the housing 5 of the receipt printer 10 is in the upward ejection orientation (step S12: Yes), the process proceeds to step S13. On the other hand, when it is determined that the housing 5 of the receipt printer 10 is not in the upward ejection orientation (step S12: No), the process proceeds to step S14. In other words, the orientation detection unit 42 detects whether the housing 5 of the receipt printer 10 is placed in the forward ejection orientation or the upward ejection orientation.

When it is determined at step S12 that the housing 5 of the receipt printer 10 is in the upward ejection orientation, the cutting mode control unit 43 sets the cutting mode of the receipt printer 10 to the partial cut mode regardless of the cutting mode determined by the cutting mode determination unit 41 (step S13). Thereafter, the process proceeds to step S14.

The cutting mode display unit 49 displays the current cutting mode of the receipt printer 10 on the display device 6 (step S14).

The print instruction acquisition unit 44 determines whether a print instruction has been received from the POS terminal (step S15). When it is determined that a print instruction has been received from the POS terminal (step S15: Yes), the process proceeds to step S16. On the other hand, when it is determined that no print instruction has been received from the POS terminal (step S15: No), step S15 is repeated.

When it is determined at step S15 that a print instruction has been received from the POS terminal, the print-data acquisition unit 45 acquires print data from the POS terminal (step S16).

The printing unit 46 prints the print data acquired from the POS terminal on the receipt sheet 3 (step S17).

The print end determination unit 47 determines whether the printing has been completed (step S18). When it is determined that the printing has been completed (step S18: Yes), the process proceeds to step S19. On the other hand, when it is determined that the printing has not been completed (step S18: No), step S18 is repeated.

When it is determined at step S18 that the printing has been completed, the movable blade control unit 48 cuts the receipt sheet 3 according to the set cutting mode (step S19). The receipt printer 10 then ends the process.

As described above, the receipt printer 10 (or printer) of the embodiment can be placed in either the forward ejection orientation in which the housing 5 of the receipt printer 10 is oriented to eject the receipt sheet 3 (or sheet) forward from the receipt printer 10 or the upward ejection orientation in which the housing 5 is oriented to eject the receipt sheet 3 upward from the receipt printer 10. The receipt printer 10 includes the cutting mode determination unit 41 that determines whether the cutting mode of the receipt sheet 3 is set to the full cut mode in which the receipt sheet 3 is completely cut off or the partial cut mode in which the receipt sheet 3 is cut such that a portion of the receipt sheet 3 remains attached to the sheet roll 5, the orientation detection unit 42 that detects whether the housing 5 is in the forward ejection orientation or the upward ejection orientation, and the cutting mode control unit 43 that sets the cutting mode of the receipt printer 10 to the partial cut mode regardless of the cutting mode determined by the cutting mode determination unit 41 when the orientation detection unit 42 detects that the housing 5 is in the upward ejection orientation. With this configuration, the ejected receipt can be prevented from falling into the receipt printer 10. Thus, the present embodiment makes it possible to prevent a problem in which a receipt, which is completely cut off and ejected upward, is left behind, falls into the receipt printer 10 through the sheet ejection port 25, and is cut into pieces when the next receipt is cut; and the pieces of the receipt accumulate in the receipt printer 10 and cause clogging of the receipt printer 10.

In the receipt printer 10 (or printer) of the embodiment, the orientation detection unit 42 detects whether the housing 5 is in the forward ejection orientation or the upward ejection orientation based on an output signal from the acceleration sensor 21. This makes it possible to reliably detect the orientation of the housing 5 with a simple configuration.

The receipt printer 10 (or printer) of the embodiment further includes the cutting mode display unit 49 that displays the current cutting mode for cutting the receipt sheet 3 (or sheet). Therefore, the current cutting mode of the receipt printer 10 can be immediately confirmed. This makes it possible to prevent the user from being confused even when the cutting mode is automatically changed from the full cut mode to the partial cut mode by the cutting mode control unit 43 as a result of placing the housing 5 of the receipt printer 10 in the upward ejection orientation.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A printer comprising:
a platen roller that feeds a sheet from a sheet roll;
a print head that performs printing on the sheet;
a cutter that cuts the sheet after the printing;
a housing that houses the platen roller, the print head, and the cutter and has a sheet ejection port through which the sheet is ejected after the printing, the housing being placeable in a forward ejection orientation in which the sheet ejection port faces forward and an upward ejection orientation in which the sheet ejection port faces upward;
a memory; and
a processor configured to execute a program that is stored in the memory to perform the steps of:
determining whether a cutting mode of the printer is set to a full cut mode in which the cutter completely cuts off the sheet from the sheet roll or a partial cut mode in which the cutter partially cuts the sheet such that a portion of the sheet remains attached to the sheet roll,
detecting whether the housing is placed in the forward ejection orientation or the upward ejection orientation, and
setting the cutting mode to the partial cut mode regardless of the determined cutting mode when the housing is placed in the upward ejection orientation.

2. The printer according to claim 1, further comprising:
an acceleration sensor that detects a direction of gravity acting on the acceleration sensor, wherein
whether the housing is placed in the forward ejection orientation or the upward ejection orientation is determined based on an output signal from the acceleration sensor.

3. The printer according to claim 1, further comprising:
a display device, wherein
the steps further include controlling the display device to display the cutting mode that is currently set.

4. The printer according to claim 3, wherein the steps further include:
when the housing is placed in the upward ejection orientation while the cutting mode of the printer is set to the full cut mode, changing the full cut mode to the partial cut mode and controlling the display device to display a message indicating that the cutting mode has been changed to the partial cut mode.

5. The printer according to claim 1, further comprising:
an operating device that receives instructions for the printer, wherein
whether the cutting mode of the printer is set to the full cut mode or the partial cut mode is determined based on information indicating a selection made by a user via the operating device.

6. The printer according to claim 1, further comprising:
a drive motor that drives the cutter, wherein
the cutter includes a fixed blade and a movable blade; and
the steps further include controlling the drive motor to move the movable blade relative to the fixed blade to cut the sheet.

7. The printer according to claim 6, wherein
in the full cut mode, the movable blade is moved by a first distance; and
in the partial cut mode, the movable blade is moved by a second distance that is less than the first distance.

8. The printer according to claim 7, wherein
the movable blade includes a blade edge that faces the fixed blade and has a bilaterally symmetrical shape, the blade edge sloping down from both ends toward a center portion thereof, a notch being formed in the center portion; and
in the partial cut mode, the movable blade is moved until the notch reaches a position at which the sheet is conveyed.

9. The printer according to claim 7, further comprising:
a stroke sensor that detects a position of a tip of the movable blade, wherein
a distance by which the movable blade is moved is controlled based on a detection signal from the stroke sensor.

10. The printer according to claim 6, wherein
the steps further include determining whether the printing on the sheet has been completed; and
the sheet is cut when the printing has been completed.

11. A method performed by a printer including a platen roller, a print head, a cutter, and a housing that houses the platen roller, the print head, and the cutter, the method comprising:
causing the platen roller to feed a sheet from a sheet roll;
controlling the print head to perform printing on the sheet;
determining whether a cutting mode of the printer is set to a full cut mode in which the cutter completely cuts off the sheet from the sheet roll or a partial cut mode in which the cutter partially cuts the sheet such that a portion of the sheet remains attached to the sheet roll;
detecting whether the housing is placed in a forward ejection orientation in which a sheet ejection port of the housing, through which the sheet is ejected after the printing, faces forward or an upward ejection orientation in which the sheet ejection port faces upward; and
setting the cutting mode to the partial cut mode regardless of the determined cutting mode when the housing is placed in the upward ejection orientation.

12. The method according to claim 11, wherein
the printer further includes an acceleration sensor that detects a direction of gravity acting on the acceleration sensor; and
whether the housing is placed in the forward ejection orientation or the upward ejection orientation is determined based on an output signal from the acceleration sensor.

13. The method according to claim 11, further comprising:
displaying the cutting mode that is currently set on a display device of the printer.

14. The method according to claim 13, further comprising:
when the housing is placed in the upward ejection orientation while the cutting mode of the printer is set to the full cut mode, changing the full cut mode to the partial cut mode and displaying, on the display device, a message indicating that the cutting mode has been changed to the partial cut mode.

15. The method according to claim 11, wherein
the printer further includes an operating device that receives instructions for the printer; and
whether the cutting mode of the printer is set to the full cut mode or the partial cut mode is determined based on information indicating a selection made by a user via the operating device.

16. The method according to claim 11, wherein
the cutter includes a fixed blade and a movable blade; and
the method further comprises moving the movable blade relative to the fixed blade to cut the sheet.

17. The method according to claim 16, wherein
in the full cut mode, the movable blade is moved by a first distance; and
in the partial cut mode, the movable blade is moved by a second distance that is less than the first distance.

18. The method according to claim 17, wherein
the movable blade includes a blade edge that faces the fixed blade and has a bilaterally symmetrical shape, the blade edge sloping down from both ends toward a center portion thereof, a notch being formed in the center portion; and
in the partial cut mode, the movable blade is moved until the notch reaches a position at which the sheet is conveyed.

19. The method according to claim 17, wherein
the printer further includes a stroke sensor that detects a position of a tip of the movable blade; and
a distance by which the movable blade is moved is controlled based on a detection signal from the stroke sensor.

20. A non-transitory computer readable storage medium storing a program for causing a processor of a printer to perform a process, the printer including a platen roller, a print head, a cutter, and a housing that houses the platen roller, the print head, and the cutter, and the process including:
causing the platen roller to feed a sheet from a sheet roll;
controlling the print head to perform printing on the sheet;
determining whether a cutting mode of the printer is set to a full cut mode in which the cutter completely cuts off the sheet from the sheet roll or a partial cut mode in which the cutter partially cuts the sheet such that a portion of the sheet remains attached to the sheet roll;
detecting whether the housing is placed in a forward ejection orientation in which a sheet ejection port of the housing, through which the sheet is ejected after the printing, faces forward or an upward ejection orientation in which the sheet ejection port faces upward; and
setting the cutting mode to the partial cut mode regardless of the determined cutting mode when the housing is placed in the upward ejection orientation.
